(19) United States
(12) Patent Application Publication
(10) Pub. No.: US 2018/0018525 A1
(43) Pub. Date: Jan. 18, 2018

(54) SYSTEM AND METHOD FOR AUTO-COMMISSIONING AN INTELLIGENT VIDEO SYSTEM WITH FEEDBACK

(71) Applicant: Carrier Corporation, Farmington, CT (US)

(72) Inventors: Zhen Jia, Shanghai (CN); Jie Xi, Shanghai (CN); Alan Matthew Finn, Hebron, CT (US)

(21) Appl. No.: 15/553,320

(22) PCT Filed: Feb. 26, 2016
(86) PCT No.: PCT/CN2016/074649

§ 371 Date: Aug. 24, 2017

(30) Foreign Application Priority Data
Feb. 26, 2015 (CN) 201510087921.0

(51) Int. Cl. G06K 9/00; H04N 7/18; G06K 9/03

(52) U.S. Cl. CPC G06K 9/00771; G06K 9/033; H04N 7/181

(57) ABSTRACT

A method of automatically commissioning an intelligent video system, includes evaluating the intelligent video system to be commissioned with a test video with an initial set of parameters to generate a result, reviewing the result associated with the intelligent video system to be commissioned via a graphical user interface, and receiving a user determination to utilize the initial set of parameters with the intelligent video system or to perform an iterative commissioning method to utilize a resultant set of parameters.

### FIELD OF THE INVENTION

The present invention is related to image processing and computer vision, and in particular to automatic commissioning of video analytic algorithms with user feedback.

### DESCRIPTION OF RELATED ART

Intelligent video surveillance systems use image processing and computer vision techniques (i.e., video analytic software) to analyze video data provided by one or more video cameras. Based on the performed analysis, events are detected automatically without requiring an operator to monitor the data collected by the video surveillance systems.

However, the installation of intelligent video surveillance systems requires the video analytic software to be configured, including setting parameters associated with the video analytic software to optimize performance of the video analytic software in correctly identifying events in the analyzed video data. This process, known as commissioning the system, is time and labor intensive, typically requiring a technician to test different combinations of parameters.

### BRIEF SUMMARY

According to an embodiment of the invention a method of automatically commissioning an intelligent video system, includes evaluating the intelligent video system to be commissioned with a test video with an initial set of parameters to generate a result, reviewing the result associated with the intelligent video system to be commissioned via a graphical user interface, and receiving a user determination to utilize the initial set of parameters with the intelligent video system or to perform an iterative commissioning method to utilize a resultant set of parameters, the iterative commissioning method including receiving a user feedback that includes a set of corrections to the result, determining a set of patterns from the set of corrections, extrapolating the set of patterns using a test video library to form a set of desired events, determining a resultant set of parameters from the set of desired events, installing the resultant set of parameters in the intelligent video system, reevaluating the intelligent video system to be commissioned with the resultant set of parameters to generate the result, reviewing the result associated with the intelligent video system to be commissioned via the graphical user interface, and receiving the user determination to utilize the resultant set of parameters with the intelligent video system or to continue the iterative commissioning method.

In addition to one or more of the features described above, or as an alternative, further embodiments could include that the initial set of parameters are a predetermined set of parameters associated with the intelligent video system.

In addition to one or more of the features described above, or as an alternative, further embodiments could include that the set of corrections to the result is a partial set of corrections to the result.

In addition to one or more of the features described above, or as an alternative, further embodiments could include that the set of patterns includes at least one high level pattern.

In addition to one or more of the features described above, or as an alternative, further embodiments could include that the set of patterns includes at least one low level pattern.

In addition to one or more of the features described above, or as an alternative, further embodiments could include that the resultant set of parameters are optimized.

In addition to one or more of the features described above, or as an alternative, further embodiments could include that the resultant set of parameters includes a plurality of sets of parameters and optimizing the resultant set of parameters includes: A. analyzing the test video with video analytic software configured with one of the sets of parameters of the plurality of sets of parameters to generate an event output; B. comparing the event output generated with the one of the sets of parameters with the desired events to calculate performance parameters that define the performance of the one of the sets of parameters; C. selecting a subsequent set of parameters of the plurality of sets of parameters based on the performance parameters associated with the one of the sets of parameters; and D. repeating steps A through C until the performance parameters are satisfactory.

In addition to one or more of the features described above, or as an alternative, further embodiments could include that the performance parameters are at least one of more true positive detections, false positive detections, false negative detections, F_{β} score, precision, and recall.

In addition to one or more of the features described above, or as an alternative, further embodiments could include that selecting a subsequent set of parameters based on the performance parameters includes: providing the calculated performance parameters to an optimization algorithm that compares the calculated performance parameters to previously calculated performance parameters.

According to an embodiment of the invention, an auto-commissioning system for automatically commissioning an intelligent video surveillance system, includes an input to receive a result from the intelligent video system to be commissioned with a test video with an initial set of parameters, a graphical user interface to allow a user to review the result and input a user determination to utilize the initial set of parameters with the intelligent video system or to continue executing the auto-commissioning system and receive a user feedback that includes a set of corrections to the result, a feedback pattern analyzer to determine a set of patterns from the set of corrections, a feedback extrapolator to extrapolate the set of patterns using a test video library to form a set of desired events; and a parameter optimizer to determine a resultant set of parameters from the set of desired events and install the resultant set of parameters in the intelligent video system, wherein the intelligent video system to be commissioned is evaluated with the test video with the resultant set of parameters to generate the result to be reviewed by the user.

In addition to one or more of the features described above, or as an alternative, further embodiments could include that the initial set of parameters are a predetermined set of parameters.

In addition to one or more of the features described above, or as an alternative, further embodiments could include that the set of corrections to the result is a partial set of corrections to the result.

In addition to one or more of the features described above, or as an alternative, further embodiments could include that the set of patterns includes at least one high level pattern.

In addition to one or more of the features described above, or as an alternative, further embodiments could include that the set of patterns includes at least one low level pattern.

In addition to one or more of the features described above, or as an alternative, further embodiments could include that the resultant set of parameters are optimized by the parameter optimizer.

Technical function of the embodiments described above includes performing an iterative commissioning method to utilize a resultant set of parameters, determining a set of patterns from the set of corrections, extrapolating the set of patterns using a test video library to form a set of ground truth events, and receiving the user determination to utilize the resultant set of parameters with the intelligent video system or to continue the iterative commissioning method.

Other aspects, features, and techniques of the invention will become more apparent from the following description taken in conjunction with the drawings.

### BRIEF DESCRIPTION OF THE SEVERAL VIEWS OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which like elements are numbered alike in the several FIGURES:

FIG. 1 is a block diagram of an intelligent video surveillance system and automatic commissioning system with feedback according to an embodiment of the present invention.

FIG. 2 is a flowchart illustrating a method of automatically commissioning the intelligent video surveillance system with feedback according to an embodiment of the present invention.

### DETAILED DESCRIPTION OF THE INVENTION

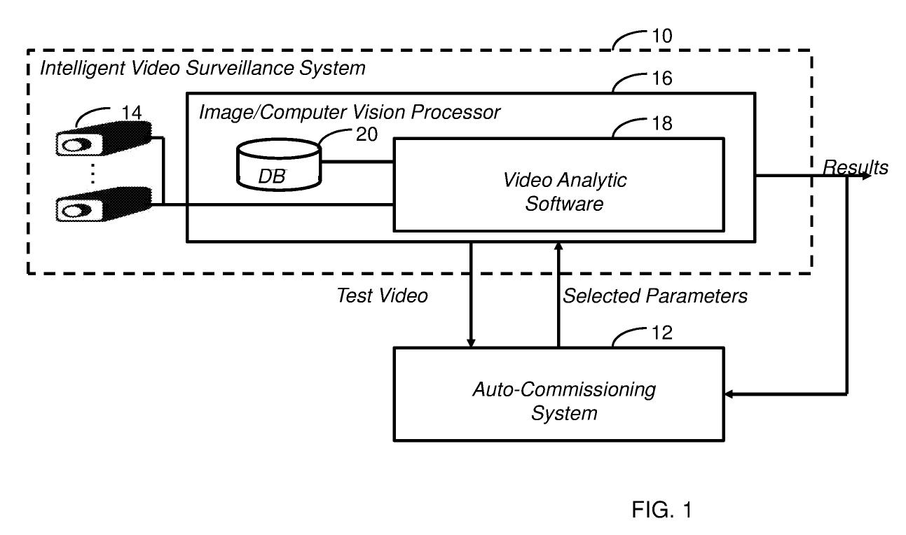

FIG. 1 is a block diagram of intelligent video surveillance system 10 and automatic commissioning system 12 according to an embodiment of the present invention. Intelligent video surveillance system 10 includes one or more video cameras 14 and image/computer vision processor 16. Video camera(s) 14 capture images and/or video data for provision to image/computer vision processor 16, which executes video analytic software 18 to analyze the images and/or video data provided by video camera(s) 14 to automatically detect objects/events within the field of view of video camera(s) 14. Objects/events detected by video analytic software 18 may include object identification, object tracking, speed estimation, fire detection, intruder detection, etc., with respect to the received images and/or video data.

The performance of video analytic software 18 is tailored for a particular application (i.e., the environment in which the intelligent video system is installed and/or the type of detection to be performed by the intelligent video system) by varying a plurality of parameters associated with video analytic software 18. These parameters may include thresholds for decision making, adaptation rates for adaptive algorithms, limits or bounds on acceptable computed values, etc. The process of selecting the parameters of video analytic software 18 during initialization of intelligent video surveillance system 10 is referred to as commissioning the system. Typically, commissioning an intelligent video surveillance system is done manually by a technician, who tests different combinations of parameter values until the video analytic software correctly interprets test data provided. However, this process is time-consuming and therefore expensive.

In the embodiment shown in FIG. 1, auto-commissioning system 12 receives results from intelligent video system 10 derived from initial/default parameters and test video. In response to the results, test video data, and minimal and/or selective technician feedback, auto-commissioning system 12 adaptively and iteratively selects parameters for the commissioning of video analytic software 18, thereby greatly reducing technician input during the commissioning process. The test video data may be provided directly from video camera 14, or may be provided by image/computer vision processor 16 from database 20, or a combination thereof. In certain embodiments, test video data can be segmented or apportioned into shorter test clips, longer test videos and test video libraries.

In general, auto-commissioning system 12 allows a technician to iteratively review test results from an intelligent video system 10, accepts technician feedback regarding the results, and adapts parameters controlling the video analytic software 18. For each application, a different set of parameters will likely be employed to maximize performance.

In one embodiment, auto-commissioning system 12 is located in a centralized control room remote from intelligent video system 10. Test video data and initial results provided by intelligent video system 10 are communicated to centralized auto-commissioning system 12 for analysis, with parameters subsequently communicated from auto-commissioning system 12 to intelligent video system 10. Similarly, database 20 may be located remote from image/computer vision processor 16 or intelligent video surveillance system 10. Communication between devices may be wired or wireless, according to well known communication protocols (e.g., Internet, LAN). In other embodiments, auto-commissioning system 12 is portable/mobile (i.e., laptop or other mobile processing device), allowing a technician commissioning a system to connect auto-commissioning system 12 to intelligent video system 10 locally. In yet other embodiments, database 20 is portable/mobile (i.e., a portable hard disk drive, flash drive, or other mobile storage device) allowing a technician commissioning a system to connect database 20 to intelligent video system 10 locally.

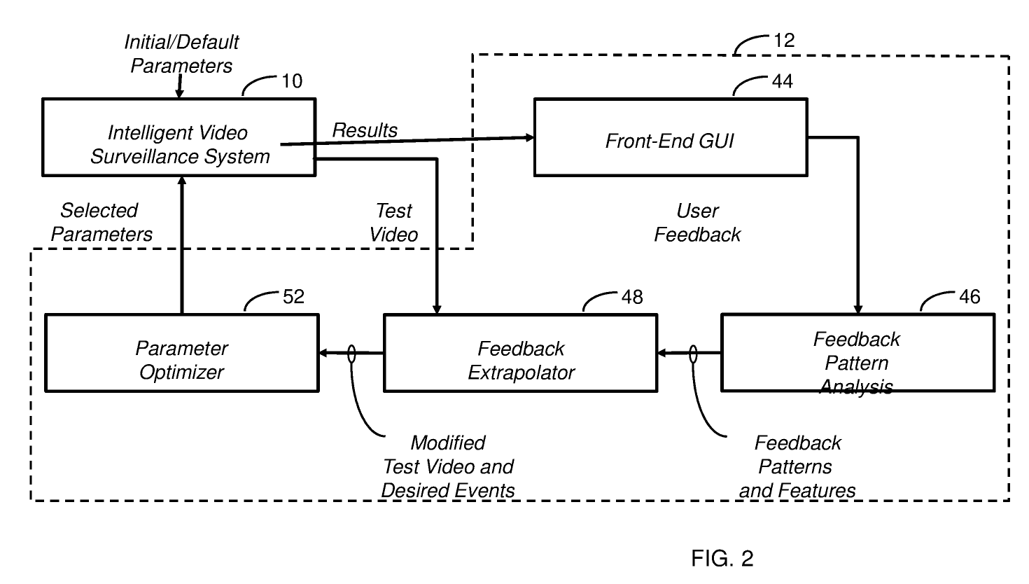

FIG. 2 is a block diagram illustrating functions performed by auto-commissioning system 12 to automatically commission intelligent video surveillance system with technician feedback according to an embodiment of the present invention. As described with respect to FIG. 1, test video and default/initial parameters are used by intelligent video system 10 to provide initial results as an input to auto-commissioning system 12, and selected parameters are provided as an output by auto-commissioning system 12 to intelligent video system 10. In the embodiment shown in FIG. 2, auto-commissioning system 12 includes front-end graphical user interface (GUI) 44, feedback pattern analyzer 46, feedback extrapolator 48, and parameter optimizer 52.

In an exemplary embodiment, an initial evaluation of intelligent video surveillance system 10 is performed and provided to auto-commissioning system 12. In an exemplary embodiment, intelligent video surveillance system 10 is run with default parameters with at least one test video. In certain embodiments, initial optimized or otherwise provided parameters are provided to intelligent video surveillance system 10. Provided parameters may be previously provided parameters, technician modified parameters based on technician knowledge or references, parameters utilized for similar intelligent video surveillance systems 10, etc. In an exemplary embodiment, the test video used by intelligent video surveillance system 10 is a representative video of the video surveillance to be utilized with system 10. In certain embodiments, the test video is a shortened video or a plurality of video clips from an extended test video database 20.

In an exemplary embodiment, results from the initial evaluation of intelligent video surveillance system 10 are sent or input to a front end graphical user interface (GUI) 44. The GUI 44 can be used to review the initial results of test video(s). In an exemplary embodiment, a technician or user can confirm true positive results, confirm true negative results, correct false positive results (false alarms), correct false negative results (add event detections), etc. Advantageously, a technician or user is not required to confirm all true positives, correct all false positives, or add a detection corresponding to every false negative. In certain embodiments, a technician or user can selectively provide corrections. In an exemplary embodiment, the auto commissioning process is iterative, with the user controlling the determination if another iteration of the auto commissioning process should be executed. If the results are satisfactory, the selected parameters are fed back to intelligent video surveillance system 10 to complete the commissioning process. Otherwise, the iterative commissioning process continues.

In an exemplary embodiment, user feedback received from GUI 44 is analyzed via feedback pattern analyzer 46 for patterns in the user's feedback with respect to the test video. In an exemplary embodiment, computer vision processing algorithms are introduced to compute visual features to identify patterns within the provided user feedback corresponding to correct or corrected detections. In an exemplary embodiment, patterns can be low level patterns and/or high level patterns to estimate visual features. For users' corrected detection results, visual features in corresponding short video segments are estimated. These visual features will then represent the salient video content information in that segment. Low-level visual features may include color, texture, edges, intensity gradients, statistical compilations, etc. For example, a color histogram and a motion gradient histogram can be used to represent the salient content of an object. High-level visual features may include image condition changes such as lighting changes, shadow regions, foreground regions, etc. High-level visual features might also include object or activity recognition, classification, semantic analysis, etc. For example, high level patterns can be based on an image's visual concepts (mountain, sea, city or lake view). Certain methods combine low-level visual features with high-level visual features for visual retrieval purposes.

In an exemplary embodiment, feedback patterns and features can be extrapolated for identification of additional test video and desired events via feedback extrapolator 48. In an exemplary embodiment, feedback patterns and features are utilized with computer vision processing algorithms to process a provided test video database 20 (or a portion of the video database) and estimate similar visual features to select or form a set of additional test video and desired events. In an exemplary embodiment, feedback extrapolator 48 identifies and matches visual features from video segments with user corrections and automatically corrects similar uncorrected video segments using similar corrections utilizing visual feature estimation and matching. Advantageously, feature extrapolation can increase the corrected detection results and identify additional video from database 20 for further optimization.

In an exemplary embodiment, parameter optimizer 52 includes an additional copy of video analytic software 18, or functionally equivalent video analytic software, that can be configured with parameters and applied to test video for analysis. The results of the analysis performed (i.e., events/objects detected as a result of the analyzed test video data) are compared with the desired events defined with respect to the test video received from feedback extrapolation 48. In an optimization process, the best parameters are determined to maximize the video analytics performance. The optimization cost function may include maximizing true positive (correct) detections, minimizing false positive (false alarm) detections, minimizing false negative (missed) detections, etc. and may also include analytic functions of detections, e.g., the well-known F_{β} score, precision, recall, etc. In an exemplary embodiment, any suitable optimization algorithm may be used, e.g., exhaustive search on a grid of discretized parameter values, various linear and non-linear gradient-based techniques, various probabilistic techniques like Bayesian Optimization, various empirical techniques such as Neural Networks, Deep Learning, and Genetic Algorithms, etc.

For example, in a gradient-based technique parameter optimizer 52 analyzes the test video with a first set of parameters (initially the initial/default parameters) and results are compared to the desired events to define first performance values, and a second set of parameters (selected, e.g., by systematic perturbation of the previous set) and results are compared to the desired events to define second performance values. The first and second set of performance values are compared to one another to define a parameter gradient that is used by parameter optimizer 52 to select a subsequent set of parameters to test. When the performance values indicate a threshold level of performance (with respect to the optimization cost function) or that no further performance improvement is occurring, the process ends and the selected parameters are provided to intelligent video surveillance system 10 for commissioning. When the performance values do not indicate a threshold level of performance or that no further performance improvement is occurring, the optimization process continues with the second set of parameters and a selected set of third parameters, etc.

In an exemplary embodiment, optimized parameters from parameter optimizer 52 are sent to intelligent video surveillance system 10 to be commissioned. Intelligent video surveillance system 10 is run with the optimized parameters and modified test video. As in a previous iteration, results from the intelligent video surveillance system 10 are sent to the GUI 44 for user review and feedback.

Similarly, as with the initial evaluation of intelligent video surveillance system 10, the new evaluation is sent to a front end graphical user interface (GUI) 44. The GUI 44 can be used to review the new results of test videos. In an exemplary embodiment, a technician or user confirm true positive results, confirm true negative results, correct false positive results (false alarms), correct false negative results (add event detections), etc. In an exemplary embodiment, the user decides if the results are satisfactory or if additional corrections and another iteration of the commissioning process should continue.

Advantageously, iterative auto commissioning with selective feedback allows the benefits of technician commissioning with reduced technician interaction burden. Further, the pattern recognition and extrapolation features of the auto commissioning system allows for efficient use of human input to match and identify correct video features. Utilizing human feedback and an automatic commissioning processes allow for a commissioned system that is robust in view of environmental changes without requiring extensive collection and annotation of videos before deployment. Further, auto commissioning system 12 allows the user to control the length of the auto commissioning process, eliminating unnecessary iterations and computing time.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of automatically comm1sswmng an intelligent video system, the method comprising:
evaluating the intelligent video system to be commissioned with a test video with an initial set of parameters to generate a result;
reviewing the result associated with the intelligent video system to be commissioned via a graphical user interface; and
receiving a user determination to utilize the initial set of parameters with the intelligent video system or to perform an iterative commissioning method to utilize a resultant set of parameters, the iterative commissioning method comprising:
receiving a user feedback that includes a set of corrections to the result;
determining a set of patterns from the set of corrections;
extrapolating the set of patterns using a test video library to form a set of desired events;
determining a resultant set of parameters from the set of desired events;
installing the resultant set of parameters in the intelligent video system;
reevaluating the intelligent video system to be commissioned with the resultant set of parameters to generate the result;
reviewing the result associated with the intelligent video system to be commissioned via the graphical user interface; and
receiving the user determination to utilize the resultant set of parameters with the intelligent video system or to continue the iterative commissioning method.

2. The method of claim 1, wherein the initial set of parameters are a predetermined set of parameters associated with the intelligent video system.

3. The method of claim 1, wherein the set of corrections to the result is a partial set of corrections to the result.

4. The method of claim 1, wherein the set of patterns includes at least one high level pattern.

5. The method of claim 1, wherein the set of patterns includes at least one low level pattern.

6. The method of claim 1, wherein the resultant set of parameters are optimized.

7. The method of claim 6, wherein the resultant set of parameters includes a plurality of sets of parameters and optimizing the resultant set of parameters includes:
A. analyzing the test video with video analytic software configured with one of the sets of parameters of the plurality of sets of parameters to generate an event output;
B. comparing the event output generated with the one of the sets of parameters with the desired events to calculate performance parameters that define the performance of the one of the sets of parameters;
C. selecting a subsequent set of parameters of the plurality of sets of parameters based on the performance parameters associated with the one of the sets of parameters; and
D. repeating steps A through C until the performance parameters are satisfactory.

8. The method of claim 7, wherein the performance parameters are at least one of more true positive detections, false positive detections, false negative detections, F score, precision, and recall.

9. The method of claim 7, wherein selecting a subsequent set of parameters based on the performance parameters includes: providing the calculated performance parameters to an optimization algorithm that compares the calculated performance parameters to previously calculated performance parameters.

10. An auto-commissioning system for automatically comm1sswmng an intelligent video system, the auto-commissioning system comprising:
an input to receive a result from the intelligent video system to be commissioned with a test video with an initial set of parameters;
a graphical user interface to allow a user to review the result and input a user determination to utilize the initial set of parameters with the intelligent video system or to continue executing the auto-commissioning system and receive a user feedback that includes a set of corrections to the result;
a feedback pattern analyzer to determine a set of patterns from the set of corrections;
a feedback extrapolator to extrapolate the set of patterns using a test video library to form a set of desired events; and
a parameter optimizer to determine a resultant set of parameters from the set of desired events and install the resultant set of parameters in the intelligent video system, wherein the intelligent video system to be commissioned is evaluated with the test video with the resultant set of parameters to generate the result to be reviewed by the user.

11. The system of claim 10, wherein the initial set of parameters are a predetermined set of parameters.

12. The system of claim 10, wherein the set of corrections to the result is a partial set of corrections to the result.

13. The system of claim 10, wherein the set of patterns includes at least one high level pattern.

14. The system of claim 10, wherein the set of patterns includes at least one low level pattern.

15. The system of claim 10, wherein the resultant set of parameters are optimized by the parameter optimizer.
